(19) United States
(12) Patent Application Publication
(10) Pub. No.: US 2016/0202999 A1
(43) Pub. Date: Jul. 14, 2016

(54) A Computing Platform, A Reconfigurable Hardware Device And A Method for Simultaneously Executing Processes On Dynamically Reconfigurable Hardware Device, Such As An FPGA, As Well As Instruction Set Processors, Such As A CPU, And A Related Computer Readable Medium

(71) Applicant: TOPIC EMBEDDED SYSTEMS B.V., Best (NL)

(72) Inventors: Dirk Otto Van Den Heuvel, Best (NL); Rene Paul Peter Zenden, Best (NL)

(21) Appl. No.: 14/912,966

(22) PCT Filed: Aug. 19, 2014
(86) PCT No.: PCT/NL2014/050568

§ 371 Date: Feb. 19, 2016

(30) Foreign Application Priority Data
Aug. 19, 2013 (NL) 2011315

(51) Int. Cl. G06F 9/44; G06F 9/50

(52) U.S. Cl. CPC G06F 9/4411; G06F 9/5044

(57) ABSTRACT

Computing platform, comprising a reconfigurable hardware device such as a Field Programmable Gate Array, FPGA, and at least one processor arranged for communicating with the reconfigurable hardware device, an operating system arranged to be executed on the at least one processor and arranged for managing execution of at least one application comprising a plurality of processes, wherein the computing platform further comprises a reconfiguring manager arranged for dynamically reconfiguring the reconfigurable hardware device at run-time based on processes to be executed and instantaneous available reconfigurable hardware device resources, wherein the reconfiguring being physically altering the reconfigurable hardware device resources by programming the hardware device, and a task manager arranged for queue communicating with the reconfiguring manager and for scheduling the processeson either one of the at least one processor and the reconfigurable hardware device.

### FIELD OF THE INVENTION

The invention generally relates to a computing platform having at least one processor as well as a reconfigurable hardware device, and more specifically to a computing platform and a method wherein the reconfigurable hardware device is dynamically reconfigured based on user preferences, processes to be executed and instantaneous available reconfigurable hardware device resources.

### BACKGROUND

Typically, hardware configurations for computing platforms having a reconfigurable hardware device are designed for a specific, dedicated and single application. Although an application's configuration may contain multiple hardware functions, the configuration is not usually designed for allowing different, unrelated applications to simultaneously share the same resources in time of a reconfigurable hardware device.

US patent application 2009/0187756 discloses a dynamic hardware and software multitasking method for a reconfigurable computing platform including reconfigurable hardware devices such as a Field Programmable Gate Array, FPGA, and software, such as dedicated hardware/software operating systems and middleware, adapted for supporting the methods, i.e. multitasking methods.

The disclosed computing platform is a heterogeneous multi-processor platform comprising one or more instruction set processors (ISPs) and a reconfigurable gate array, for example an FPGA, adapted for dynamic hardware/software multitasking.

The underlying problem acknowledged in that US patent application is a scheduling problem where based on quality-of-service metrics, tasks are dynamically swapped from an ISP to reconfigurable hardware and vice versa. The method comprises a functional model in which tasks are partitioned to be executed on either hardware or in software. Described is that the execution of tasks requires virtualization of the underlying ISP and hardware to ensure that software and hardware functionality is the same to be able to swap the tasks dynamically and during runtime from the hardware to the ISP and vice-versa.

A lot of work has already been done on describing methods for determining pre-emptive scheduling, i.e. scheduling of the tasks on either one of a processor and a hardware device based on pre-conditions. US patent application 2009/0187756 discloses a method which is flexible in the use of the available resources of the computing platform.

The method involves the steps of first configuring the reconfigurable device so that it is capable of executing a first plurality of hardware tasks, subsequently executing a first set of tasks of an application substantially simultaneously on the computing platform, interrupting the execution of the first set of tasks wherein the interruption occurs while executing a task.

Herein after the reconfigurable hardware device is reconfigured such that at least one new hardware task other than one of the first plurality of hardware tasks can be executed, and then executing a second set of tasks substantially simultaneously on the platform to further execute the application, wherein the application comprises a plurality of tasks, a number of the tasks being selectively executable as a software task on a processor or as a hardware task on the reconfigurable hardware device.

The main aspect of the above mentioned US patent application is that execution of hardware and software tasks can be interrupted and relocated anywhere on the heterogeneous platform, and task execution can be resumed. Using QoS metrics, this can be performed at real-time. The above constraints and limits the implementation of the hardware and software infrastructure as well as the software middleware to manage the executed tasks, reconfiguration of the tiles and routing infrastructure.

A drawback of the disclosed method and computing platform is that the reconfigurable hardware device should be relatively large in size, as it is configured such that it is able to execute a plurality of hardware tasks. This leads to a waste in the reconfigurable hardware device resources as the parts of the hardware device configured to execute certain tasks but wherein these tasks are subsequently scheduled on the processor instead of on the hardware device, are not utilized.

A further drawback of the disclosed method and computing platform is the lack in flexibility of the types of tasks to be executed on the reconfigurable hardware device. In case tasks pop up which do not belong within the first plurality of hardware tasks, these tasks cannot be performed on the reconfigurable hardware device. As such, the functionality of the hardware device is bound to the initial first set of plurality of hardware tasks.

It is therefore an objective of the invention to provide for a computing platform and a method in which processes can be scheduled more flexible either on the processor or on the hardware device, and wherein the capacity of the hardware device is utilized more efficiently.

It is a further objective of the invention to maintain current software platform development and execution flow and provide the means to seamlessly incorporate hardware processes in the program execution with the same execution characteristics as software processes.

### SUMMARY

In order to accomplish that objective, the invention, according to a first aspect thereof, provides for a computing platform, comprising a reconfigurable hardware device such as a Field Programmable Gate Array, FPGA, and at least one processor arranged for communicating with the reconfigurable hardware device, and an operating system arranged to be executed on the at least one processor and arranged for managing execution of at least one application comprising a plurality of processes.

The computing platform further comprises a first programmed concurrent process execution frame work comprising of one or multiple pre-defined reconfigurable areas on the at least one reconfigurable hardware device, a routing infrastructure arranged to exchange data within the frame work and a reconfigurable infrastructure arranged to re-program the reconfigurable areas, and a library of re-locatable and instantaneously available user-defined hardware functions, wherein the hardware functions are compatible with the pre-defined reconfigurable areas in the concurrent execution frame work, and a reconfiguring manager arranged for dynamically reconfiguring the reconfigurable hardware device at run-time based on processes to be executed and instantaneous available reconfigurable hardware device resources, wherein the reconfiguring being physically altering the reconfigurable hardware device resources by programming the hardware device, and a task manager arranged for queue communication with the ISP in the form of a physical instantiation or as a softcore as part of a reconfigurable hardware device with the reconfiguring manager and for scheduling the processes on either one of the at least one processor and the at least one reconfigurable hardware device.

The invention is based on the principle that the functionality of different blocks of a reconfigurable hardware device, i.e. an FPGA, can be altered during run-time, i.e. programmed, such that the functionality matches processes to be performed.

A reconfigurable hardware device, in the context of the present invention, comprises typically a plurality of configurable logic blocks and an interconnect structure for interconnecting the configurable logic blocks. A reconfigurable hardware device can be a logic gate array, e.g. an FPGA. Reconfiguring the hardware device means programming the functionality of the logic blocks, i.e. altering the actual hardware design of an FPGA, for example by using a partial bitstream as a result of the synthesis of a Very High Speed Integrated Circuit Hardware Description Language, VHDL, design. As such, reconfiguring is considered to be comprising the implementation of the functionality in the FPGA fabric.

The reconfiguring manager is, in an example, arranged for the partitioning and allocation of logic blocks of the FPGA. In order to efficiently reconfigure the FPGA, the inventors noted that these functions should be based on user preferences, processes to be executed and instantaneous available reconfigurable hardware device resources. An FPGA partitioning file is provided which divides the FPGA logic in a plurality of partitions, for example equal partitions.

Every partition is used as an execution environment for a process allocated to the hardware. Next, the FPGA function blocks are provided, i.e. function blocks defining the functionality required for a certain task. These function blocks are compiled for a particular partition of the FPGA. The reconfiguring manager is, in an example, further arranged for controlling the instantiation and release of the function blocks to the partitions reserved for the corresponding function blocks.

Many different applications are suitable for using a computing platform according to the invention. Especially, applications with limited space or resources, such as mobile phones, require flexibility and powerful computing engine at the same time, such as multimedia applications.

The computing platform according to the present invention, may be implemented in a single casing, wherein at least one processor and the reconfigurable hardware device are comprised, such as, for example, an FPGA with integrated ISP or pure FPGA fabric with a softcore ISP device platform, or may be implemented in multiple casings, for example the at least one processor separated from the reconfigurable hardware device.

Scheduled resource-sharing is a characteristic of an application running processes on an instruction set processor. The inventors noted that the reconfigurable characteristics of a reconfigurable hardware device allow for the use of the resources of the hardware device in a similar manner as is common with application processors, given the method and execution framework according to the invention.

The method according to the invention provides the possibility that current software platform developments and execution flow are maintained, and provide the means to seamlessly incorporate hardware executed processes, including dynamic creation and removal. Task management and data stream handling are, in an embodiment, solved using middleware and an autonomous operated data routing mechanism.

The at least one processor may be, for example, in the form of a physical instantiation or as a softcore as part of a reconfigurable hardware device.

In an embodiment of the invention, the processor is arranged for communicating with the reconfigurable hardware device via a hardware management unit comprised in the computing platform, wherein the hardware management unit is further arranged for enabling direct inter-process communication.

Direct inter-process communication means, for example, that the different function blocks, i.e. the processing units running the processes, in the FPGA are able to communicate, i.e. share data, with each other without intervention of the processor, for example the Operating System. Further, the different function blocks may communicate directly to processes running on the processor, or vice versa. Inter-process communication also provides the possibility for processes to synchronize their actions.

In a further embodiment, the hardware management unit is at least partly comprised in the reconfigurable hardware device.

In an even further embodiment, the reconfigurable hardware device comprises a plurality of user defined partitions, each partition being dynamically reconfigurable by the reconfiguring manager, wherein the hardware resources can be physically altered by the reconfiguring manager.

A partition is defined as a plurality of configurable logic blocks in the FPGA, wherein each tile is arranged for performing a task using a process. The allocation of partitions, i.e. the size and location, and the programming of these partitions is a responsibility of the reconfiguration manager. In order for increasing the efficiency of the FPGA, the reconfiguration manager is arranged to place the partitions having functionality to execute processes which need to share data with each other, closely to each other on the FPGA fabric.

In an example, dynamically reconfiguring the reconfigurable hardware device takes place based on the sizes of partitions, the processes to be executed, and the amount of reconfigurable partitions.

The advantage of the above mentioned example is that the resources of the FPGA are utilized more efficiently, as the size of the partitions is matched to the functionality the partitions need to perform. This leads to the situation that it is possible to schedule more processes on the reconfigurable hardware device, compared to prior state-of-art systems. As in the prior state-of-the-art systems it will occur that parts of the FPGA's are programmed with functionality which is in fact superfluous as the processes to be executed do not require this functionality.

In another embodiment of the invention, the operating system further comprises a kernel, and wherein the reconfiguring manager and the task manager are comprised in the kernel.

The advantage of the above mentioned embodiment is that computing platform can easily be integrated with known operating systems having known kernels.

In yet another embodiment of the present invention, the computing platform further comprises a memory for the reconfigurable hardware device and the processor, wherein the memory comprises logical building blocks representing logical functions for the reconfigurable hardware device, wherein the reconfiguring manager is arranged for dynamically reconfiguring the reconfigurable hardware device at run-time using the logical building blocks in the memory.

The advantage of the above mentioned embodiment is that an end user is able to modify logical building blocks in the memory, which building blocks are used by the reconfiguring manager for programming an FPGA, for example by using a library comprising these building blocks. Adding new functionality or modifying functionality of the logical building blocks is easily done by updating the library of available logical building blocks in the memory.

In a second aspect, the invention provides in a method of dynamically reconfiguring a computing platform, said platform comprising a reconfigurable hardware device such as a Field Programmable Gate Array, FPGA, and a processor arranged for communicating with the reconfigurable hardware device and an operating system arranged to be executed on the processor and arranged for managing execution of at least one application comprising a plurality of processes.

The method comprising the steps of dynamically reconfiguring the reconfigurable hardware device, by a reconfiguring manager, at run-time based on user preferences, processes to be executed and instantaneous available reconfigurable hardware device resources, wherein the reconfiguring being physically altering the reconfigurable hardware device resources by programming the hardware device, and scheduling the processes, by a task manager in communication with the reconfiguring manager, on either one of said processors and the reconfigurable hardware device.

In an embodiment of this aspect, the method further comprises the steps of direct inter-process communication via a hardware management unit comprised in the computing platform.

In a further embodiment, the reconfigurable hardware device comprises a plurality of partitions, each partition being dynamically reconfigurable by the reconfiguring manager, wherein the step of dynamically reconfiguring the reconfigurable hardware device comprises physically altering hardware resources of the partition by dynamically programming the hardware device

In yet a further embodiment, the reconfigurable hardware device comprises a plurality of partitions, each partition being dynamically reconfigurable by the reconfiguring manager, wherein the step of dynamically reconfiguring the reconfigurable hardware device comprises physically altering hardware resources of the partition by dynamically programming the hardware device.

In an even further embodiment, the step of dynamically reconfiguring the reconfigurable hardware device further comprises the steps of determining sizes of partitions based on processes to be executed, allocating said sizes on said reconfigurable hardware device, and programming the partitions with functionality corresponding to the processes to be executed. In an example, the method further comprises the step of managing the tiles on the reconfigurable hardware device.

In an example, the step of dynamically reconfiguring the reconfigurable hardware device is to be performed by a kernel comprised in the operating system.

In a third aspect, the invention provides in a computer readable medium storing an operating system comprising a kernel, which operating system, when executed on a computing platform comprising a reconfigurable hardware device such as a Field Programmable Gate Array, FPGA, and a processor arranged for communicating with said reconfigurable hardware device, performs the method comprising dynamically reconfiguring the reconfigurable hardware device, by a reconfiguring manager, at run-time based on user preferences, processes to be executed and instantaneous available reconfigurable hardware device resources, wherein the reconfiguring being physically altering the reconfigurable hardware device resources by programming the hardware device, and scheduling the processes, by a task manager in communication with the reconfiguring manager, on either one of said processor and the reconfigurable hardware device.

In a fourth aspect, the invention provides in a reconfigurable hardware device, such as a Field Programmable Gate Array, FPGA, comprising a concurrent process execution frame work comprising of one or multiple pre-defined reconfigurable areas, wherein the reconfigurable hardware device is arranged to be operated in a computing platform according to the present invention.

The invention will now be explained in more detail with reference to the appended figures, which merely serve by way of illustration of the invention and which must not be construed as being limitative thereto.

### BRIEF DESCRIPTION OF THE DRAWINGS

FIG. 1 shows, in a schematic form, a typical application of a heterogeneous reconfigurable computing platform evolving over time according to an embodiment of the present invention.

FIG. 2 shows, in a schematic form, a generic process communication network suitable for use with a computing platform according to the present invention.

FIG. 3 shows, in a schematic form, an example of a computing platform comprising a multi-core processor and a configurable hardware device, according to the present invention.

### DETAILED DESCRIPTION

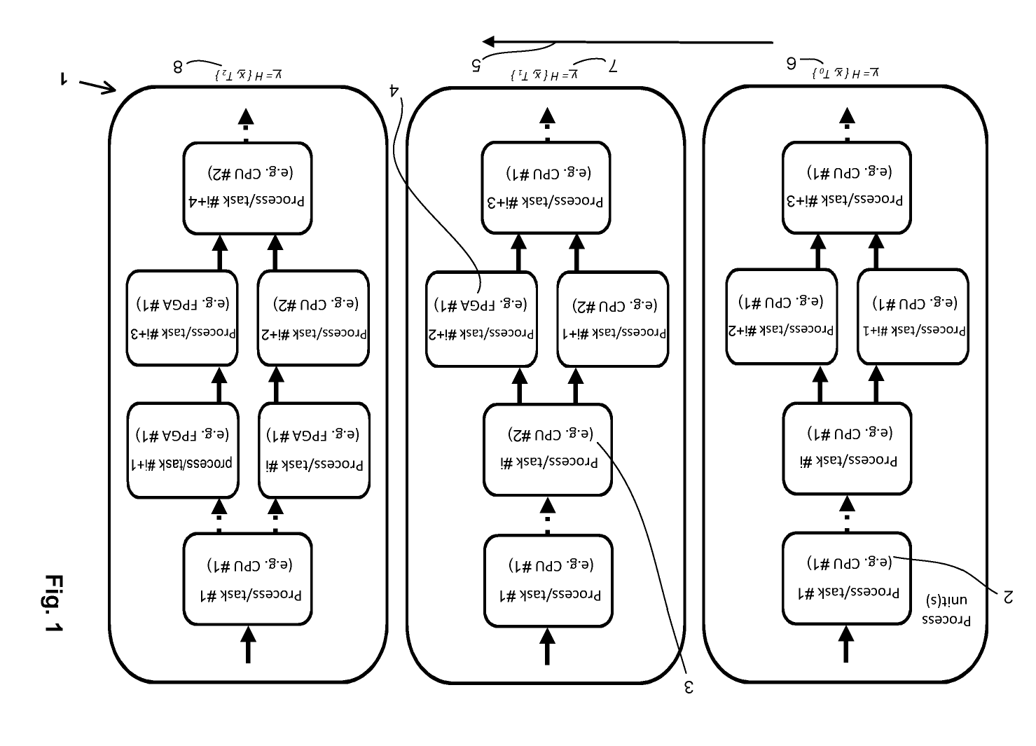

FIG. 1 shows, in a schematic form, a typical application of a heterogeneous reconfigurable computing platform 1 according to an embodiment of the present invention.

A characteristic of such a platform is that it consists of multiple processing units, such as ISPs, FPGAs, DSPs and/or GPUs 2, 3, 4. The identified processes, part of the overall application, have functionality which can be executed on any processing unit 2, 3, 4 within the computing platform, being either a reconfigurable hardware device such as a Field Programmable Gate Array “FPGA #1” 4 and at least one processor “CPU #1” 2 and/or “CPU #2” 3.

The heterogeneous reconfigurable computing platform 1 is suitable to run several applications in concurrence. Each application consists of one or more processes. Over time 5, the configuration of the processes characterising the application can change according to context changes at time reference T₀ 6. The application has mapped processes only at the CPU with reference numeral CPU#1. At time reference T₁ 7, the same architecture of the application is in place, but the processes are dynamically relocated at different processing units with reference numeral CPU#1 2, CPU#2 3 and FPGA#1 4. These applications comprise a plurality of processes which are either consecutively or in parallel. At time reference T₂ 8 the process architecture of the application has changed and processes are dynamically relocated and reconfigured on different processing units.

A process manager running on the computing platform 1 is arranged for scheduling these processes on either one of the “CPU #1” 2, “CPU #2” 3 and the “FPGA 1” 4.

To dynamically reconfigure an application, the implementation of the functionality must be available for that target processing unit. It is up to an end user, i.e. a programmer to determine the actual partitioning, resource allocation and function assignment within the processing network based on parameters suitable for the particular application, i.e. based on the processes to be executed and instantaneous available reconfigurable hardware device resources.

In this context processes and threads implement programmed functionality executed on a process unit. Based on applied input data and internal state, they produce output data. The reconfigurable properties of the methodology allow for relocating functionality from one processing unit to another, re-using the resources of the computing platform. Relocation and reconfiguration is relevant when the execution context of the application is changed due to changed e.g. power-, performance-, resource- or priority-requirements.

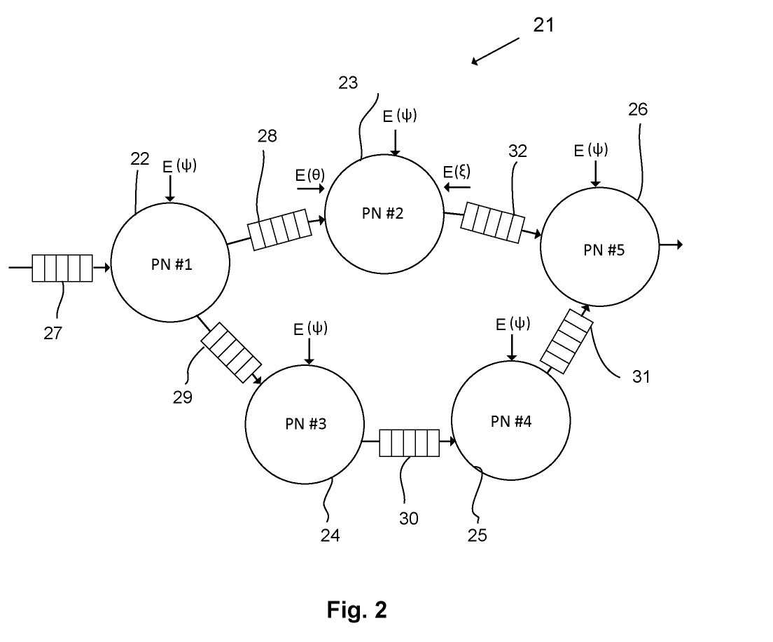

FIG. 2 shows, in a schematic form, a generic process communication network 21 suitable for use with a computing platform 1 according to the present invention.

A network typically comprises a plurality of nodes, i.e. “PN #1” 22, “PN #2” 23, “PN #3” 24, “PN #4” 25, “PN #5 26” and corresponding queues 27 to 32, respectively. Nodes represent process functionality, being e.g. processes, threads and may be executed on any processing unit part of the heterogeneous platform 1 such as at least one processors, i.e. an instruction processor, and a reconfigurable hardware device, i.e. a programmable device.

The nodes 22-26 communicate with each other or with the environment using their queues 27-32. These queues temporarily buffer data and allow for data driven process synchronisation. Alternatively, process synchronisation is organised via threats. In that case the queues make it possible to run processes asynchronously. A network consisting of nodes and queues is denoted as a process network. In general, every application running on a heterogeneous platform 1 can be considered to be modelled as a processing network.

A dynamically reconfigurable heterogeneous processing network 1 allows re-arrangement of the processing network during application execution on any processing unit. Data and application execution integrity are guaranteed by use of the process execution manager.

For software implementations, the above is managed e.g. by the OS. Implementation of the dynamically reconfigurable part on a programmable device or FPGA is not trivial and requires a non-trivial approach with respect to managing FPGA execution. Typical usage of FPGA devices is to give it the functionality on power-up and maintain executing that same function during the complete operational period of a platform.

Dynamic partial reconfiguration requires an infrastructure on the FPGA as well as on the ISP to modify partially the functionality of the device and maintain functional integrity of the executed unaltered processes. Performing partial FPGA reconfiguration dynamically during program execution under control of a reconfiguring manager gives the execution of processes on programmable devices similar behaviour as to the execution of processes on an instruction set processor. This, in an example, comprises a controlled execution framework on the FPGA as well as a dedicated reconfiguration infrastructure to reconfigure a part of the programmable device under control of a reconfiguring manager.

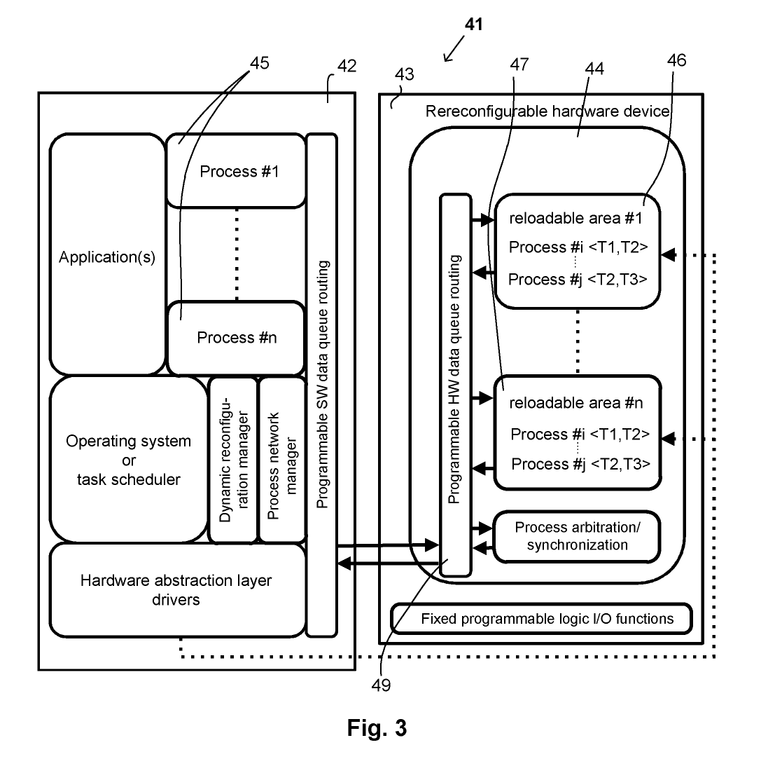

FIG. 3 shows, in a schematic form, an example of a computing platform 41 comprising a multi-core processor, i.e. an instruction set processor 42, and a programmable logic device, i.e. a configurable hardware device 43, according to the present invention.

Interaction between the individual processes 45, 46, 47 is realised using queues, implemented in software or hardware depending on the execution locations of the processes 45, 46, 47. Routing 49 of data to and from the software queues is implicitly realized using standard software implementation methods. Routing 49 of data between queues in hardware or between hardware and software require a physical implementation of data routes. The routing infrastructure 49 to and from the data queues is, in an example, a part of the dynamic reconfigurable framework 44.

The instruction set processor system 42 is able to execute multiple processes 45. Reconfiguration of the software process execution is performed under control of the reconfiguration manager as part of an OS. The programmable logic device 43 is arranged to execute processes 46, 47 in true-concurrence. The physical location at which these processes 46, 47 are executed on the programmable logic device 43 is reprogrammable by means of partial reconfiguration techniques. The concurrent execution framework 44, the partial reconfiguration techniques, the reconfiguring manager and the process manager together make it possible to implement a dynamic reconfigurable process execution framework 44.

The proposed dynamic reconfigurable process execution framework 44 facilitates seamlessly the integration of programmable logic hardware in a typical software development environment by providing similar behaviour for hardware and software processes 45, 46, 47 without compromising standard development methods for either discipline. The method allows the developers to address application development on a heterogeneous process platform from a single implementation context using an abstract application programming interface for both hardware and software functions. The underlying functionality must be implemented for every process unit where the process has to be able to be executed on. The infrastructure provides means to handle the implementation aspects in both hardware and software to facilitate the method where all low-level details are taken care of.

The present invention has been explained in the foregoing by means of a number of examples. As those skilled in the art will appreciate, several modifications and additions can be realised without departing from the scope of the invention as defined in the appended claims.

1. A computing platform, comprising:
at least one reconfigurable hardware device;
at least one processor arranged for communicating with the reconfigurable hardware device;
an operating system arranged to be executed on the at least one processor and arranged for managing execution of at least one application comprising a plurality of processes, wherein the computing platform further comprises:
a first programmed concurrent process execution frame work, comprised within the at least one reconfigurable hardware device, comprising one or multiple pre-defined reconfigurable areas on the at least one reconfigurable hardware device and a routing infrastructure arranged to exchange data within the frame work, the computing platform further comprising a reconfigurable infrastructure arranged to re-program the reconfigurable areas;
a library of re-locatable and instantaneously available user-defined hardware functions, wherein the hardware functions are compatible with the pre-defined reconfigurable areas in the concurrent execution frame work;
a reconfiguring manager arranged for dynamically reconfiguring the reconfigurable hardware device at run-time based on processes to be executed and instantaneous available reconfigurable hardware device resources, wherein the reconfiguring being physically altering the reconfigurable hardware device resources by programming the hardware device; and
a task manager arranged for queue communicating with the reconfiguring manager and for scheduling the processes on either one of the at least one processor and the at least one reconfigurable hardware device.

2. The computing platform according to claim 1, wherein the routing infrastructure is arranged for exchanging data within the frame work using data queues.

3. The computing platform according to claim 1, wherein the task manager is further arranged for dynamically rearranging the processes to be executed and scheduled, according to programmed context.

4. The computing platform according to claim 1, wherein the reconfigurable hardware device comprises a plurality of tiles, each tile being real-time dynamically reconfigurable by the reconfiguring manager, wherein the dynamically reconfiguring the reconfigurable hardware device comprises physically altering hardware resources of the tile by dynamically programming the hardware device.

5. The computing platform according to claim 4, wherein the routing infrastructure is arranged for exchanging data between the plurality of tiles.

6. The computing platform according to claim 4, wherein the dynamically reconfiguring the reconfigurable hardware device comprises determining sizes of tiles based on processes to be executed, allocating the sizes on the reconfigurable hardware device, and programming the tiles with functionality corresponding to the processes to be executed.

7. The computing platform according to claim 4, wherein the reconfiguring manager is further arranged for managing the tiles on the reconfigurable hardware device.

8. The computing platform according to claim 1, wherein the operating system further comprises a kernel, and wherein the reconfiguring manager and the task manager are comprised in the kernel.

9. The computing platform according to claim 1, wherein the computing platform further comprises a shared memory for the reconfigurable hardware device and the processor, wherein the shared memory is utilized by the processes to exchange data irrespective of whether the processes are scheduled on the at least one processor and the reconfigurable hardware device.

10. A method of dynamically reconfiguring a computing platform, the platform comprising at least one reconfigurable hardware device, a processor arranged for communicating with the at least one reconfigurable hardware device and an operating system arranged to be executed on the processor and arranged for managing execution of at least one application comprising a plurality of processes, wherein the computing platform further comprises:
a first programmed concurrent process execution frame work, comprised within the at least one reconfigurable hardware device, comprising one or multiple pre-defined reconfigurable areas on the at least one reconfigurable hardware device and a routing infrastructure arranged to exchange data within the frame work, the computing platform further comprising a reconfigurable infrastructure arranged to re-program the reconfigurable areas;
a library of re-locatable and instantaneously available user-defined hardware functions, wherein the hardware functions are compatible with the pre-defined reconfigurable areas in the concurrent execution frame work;
a reconfiguring manager arranged for dynamically reconfiguring the reconfigurable hardware device at run-time based on processes to be executed and instantaneous available reconfigurable hardware device resources, wherein the reconfiguring being physically altering the reconfigurable hardware device resources by programming the hardware device;
a task manager arranged for queue communicating with the reconfiguring manager and for scheduling the processes on either one of the at least one processor and the at least one reconfigurable hardware device;
the method comprising the steps of:
dynamically reconfiguring the reconfigurable hardware device, by a reconfiguring manager, at run-time based on user preferences, processes to be executed and instantaneous available reconfigurable hardware device resources, wherein the reconfiguring being physically altering the reconfigurable hardware device resources by programming the hardware device;
scheduling the processes, by a task manager in communication with the reconfiguring manager, on either one of the processor and the reconfigurable hardware device, and
exchanging, using the routing infrastructure, data within the frame work.

11. The method according to claim 10, wherein the step of exchanging data within the frame work comprises exchanging, using the routing infrastructure, data within the frame work using data queues.

12. The method according to claim 10, further comprising the steps of direct inter-process communicating via a hardware management unit comprised in the computing platform.

13. The method according to claim 10, wherein the reconfigurable hardware device comprises a plurality of tiles, each tile being dynamically reconfigurable by the reconfiguring manager, wherein the step of dynamically reconfiguring the reconfigurable hardware device comprises physically altering hardware resources of the tile by dynamically programming the hardware device.

14. The method according to claim 13, wherein the step of exchanging data within the frame work comprises exchanging data between the plurality of tiles comprised in the reconfigurable hardware device.

15. The method according to claim 10, wherein the step of dynamically reconfiguring the reconfigurable hardware device further comprises the steps of:
determining sizes of tiles based on processes to be executed,
allocating the sizes on the reconfigurable hardware device, and
programming the tiles with functionality corresponding to the processes to be executed.

16. The method according to claim 10, further comprising the step of managing the tiles on the reconfigurable hardware device.

17. The method according to claim 10, wherein the step of dynamically reconfiguring the reconfigurable hardware device is performed by a kernel comprised in the operating system.

18. A computer readable medium storing an operating system comprising a kernel, which operating system, when executed on a computing platform comprising a reconfigurable hardware device and a processor arranged for communicating with the reconfigurable hardware device, performs the method comprising:
dynamically reconfiguring the reconfigurable hardware device, by a reconfiguring manager, at run-time based on user preferences, processes to be executed and instantaneous available reconfigurable hardware device resources, wherein the reconfiguring being physically altering the reconfigurable hardware device resources by programming the hardware device;
scheduling the processes, by a task manager in communication with the reconfiguring manager, on either one of the processor and the reconfigurable hardware device; and
exchanging, using a routing infrastructure comprised within the reconfigurable hardware device, data within the frame work.

19. (canceled)

20. The computing platform of claim 1, wherein the at least one reconfigurable hardware device is a Field Programmable Gate Array (FPGA).
